(19) United States
(12) Patent Application Publication
(10) Pub. No.: US 2018/0231467 A1
(43) Pub. Date: Aug. 16, 2018

(54) MULTI-COLOR FLUORESCENT EXCITATION AND DETECTION DEVICE AND NUCLEIC ACID ANALYSIS APPARATUS EMPLOYING SAME

(71) Applicant: Delta Electronics Int'l (Singapore) Pte Ltd, Singapore (SG)

(72) Inventors: Bo Ma, Singapore (SG); Qian Liang, Singapore (SG); Jei-Yin Yiu, Singapore (SG)

(21) Appl. No.: 15/954,483

(22) Filed: Apr. 16, 2018

Related U.S. Application Data
(63) Continuation-in-part of application No. 15/700,791, filed on Sep. 11, 2017.
(60) Provisional application No. 62/393,211, filed on Sep. 12, 2016.
(60) Provisional application No. 62/393,223, filed on Sep. 12, 2016.

(30) Foreign Application Priority Data
Mar. 6, 2018 (SG) 10201801823U

(51) Int. Cl. G01N 21/64; B01L 7/00; G01N 21/03

(52) U.S. Cl. CPC G01N 21/6486; G01N 21/6452; B01L 7/52; G01N 21/0332; B01L 2300/046; B01L 2300/0829; G01N 2201/0636; G01N 2021/6421; G01N 2021/6471; G01N 2021/6478; G01N 2201/02; G01N 2201/0626; G01N 2201/0627; G01N 2021/0367

(57) ABSTRACT

A multi-color fluorescent excitation and detection device comprises at least one illumination module, a cartridge and at least one detection module. The illumination module provides an illumination light at specified range of wavelengths. The cartridge comprises a detection chip comprising plural detection wells arranged around the peripheral of the detection chip. The detection chip is circular shape. Each of the detection wells is accommodated a corresponding fluorescent dye therein. Each of the detection wells includes a first wall and a second wall. The illumination light transmits through the first wall to illuminate on the fluorescent sample so as to excite a fluorescent signal, and the fluorescent signal generated from the fluorescent sample transmits through the second wall. The detection module receives the fluorescent signal and convert the fluorescent signal to an electrical signal.

### CROSS-REFERENCE TO RELATED APPLICATION

This application is a continuation-in-part of U.S. patent application Ser. No. 15/700,791 filed on Sep. 11, 2017, which claims the benefit of U.S. Provisional Application Ser. No. 62/393,211 filed on Sep. 12, 2016 and the benefit of U.S. Provisional Application Ser. No. 62/393,223 filed on Sep. 12, 2016, the entirety of which is hereby incorporated by reference. This application also claims the priority to Singapore Patent Application No. 10201801823U filed on Mar. 6, 2018, the entirety of which is hereby incorporated by reference.

### FIELD OF THE INVENTION

The present invention relates to a fluorescence detection device, and more particularly to a multi-color fluorescent excitation and detection device and a nucleic acid analysis apparatus employing the multi-color fluorescent excitation and detection device.

### BACKGROUND OF THE INVENTION

The demand of acquiring large amounts of a specific segment of DNA efficiently for different purposes is booming in recent years. Among the entire existing DNA sequencing techniques, Polymerase Chain Reactions (PCR) is one of the most economical and straightforward techniques amplifying billion copies of targeted DNA segments in short period of time. The applications of PCR technique are broadly adopted, such as selective DNA isolation for genetic identification, forensic analysis for analyzing ancient DNA in archeology, medical applications for genetic testing and tissue typing, fast and specific diagnosis of infectious diseases for hospitals and research institutes, inspection of environmental hazards for food safety, genetic fingerprint for investigating criminals, and so on. For PCR technique, only small amount of DNA samples are required from blood or tissues. By utilizing fluorescent dye into the nucleic acids solutions, the amplified DNA segments could be detected through the help of fluorescent molecules.

To simultaneously detect and analyze the presence of targeted nucleic acids in a batch of biological samples, fluorescent detection technique is usually applied. After the light source at specific wavelength illuminates on the targeted nucleic acids, the DNA-binding dyes or fluorescein-binding probes of the nucleic acids would react, and fluorescent signals are emitted. The fluorescent signal is an indication of the existence of the targeted nucleic acids. This technique has been employed for the novel PCR technique, which is called isothermal amplification method. An optical device is essential to detect the fluorescent light emitted from the specific nucleic acids segments for qPCR technique. The optical device has to provide a light source to excite fluorescent probes at their specific wavelengths, and in the meanwhile, it detects the fluorescent signals emitted from the probes.

Instead of using thermal cycling, isothermal amplification relies on proteins that use in vivo mechanisms of DNA/RNA synthesis and dominated by enzyme activity. Therefore, miniaturize isothermal system has advantages of simple design and extremely low energy consumption. Today, various isothermal based amplification methods in terms of assay complexity (multiple enzymes or primers), acceptable detection sensitivity, and specificity have been developed, including nucleic acid sequence-based amplification (NASBA), strand displacement amplification (SDA), helicase-dependent amplification (HDA), loop-mediated isothermal amplification (LAMP), recombinase polymerase amplification (RPA) and nicking enzyme amplification reaction (NEAR).

The fluorescent detection systems have been well developed in many fields, such as the application of fluorescence spectroscopy and fluorescence microscopy. An array of single color light source with a set of filters and optical components could easily apply on particular fluorescent probe. However, most of the existing fluorescent detection systems are bulky, complex and expensive. Moreover, most of the fluorescent signal emitted from the fluorescent detection system has low Signal-to-Noise ratio (SNR). Besides, the development of fluorescent detection device for portable isothermal method lags behind its biochemical technique development. Because isothermal amplification bears higher tolerance on the sample purity, most of commercial isothermal platforms focus on creating a stable temperature environment and detection methods with middle and high throughput. More importantly, as most isothermal based devices are preferred in mobile detection environment, and therefore the system is highly integrated. As a result, most prevalent optical unit designs, though being widely adopted by most instrument manufacturers, are no longer suitable for the isothermal based device.

### SUMMARY OF THE INVENTION

An object of the present invention is to provide a multi-color fluorescent excitation and detection device based on non-refractive method for achieving high signal to noise ratio, minimizing the overall size and weight and still providing superior performance for a portable isothermal PCR system with low cost, and allowing the deviation of the detection well.

Another object of the present invention is to provide a multi-color fluorescent excitation and detection device with compact optical structure for preventing the difficulty of alignment and assembly, high performance, robust design structure, and innovative fluorescent chamber design for preventing light transmission loss and maintaining high signal to noise ratio.

A further object of the present invention is to provide an all-in-one nucleic acid analysis apparatus with isothermal based amplification, so that the processes of sample purification, nucleic acid extraction, nucleic acid amplification and/or nucleic acid detection may be performed on the all-in-one apparatus to realize nucleic acid analysis in real time.

A further object of the present invention is to provide a nucleic acid analysis apparatus capable of simultaneously detecting multiple targets with isothermal based amplification.

In accordance with an aspect of the present disclosure, there is provided a multi-color fluorescent excitation and detection device. The multi-color fluorescent excitation and detection device comprises at least one illumination module, a cartridge and at least one detection module. Each of the at least one illumination module provides an illumination light at specified range of wavelengths. The cartridge comprises a detection chip comprising plural detection wells arranged around the peripheral of the detection chip. The detection chip is circular shape. Each of the detection wells is accommodated a corresponding fluorescent sample therein. Each of the detection wells includes a first wall and a second wall. The illumination light transmits through the first wall to illuminate on the fluorescent sample within the detection well so as to excite a fluorescent signal. The fluorescent signal emitted from the fluorescent sample transmits through the second wall. The at least one detection module receives the fluorescent signal emitted from the fluorescent sample through the corresponding second wall and converts the fluorescent signal to an electrical signal.

According to an aspect of the embodiment of the present invention, there is provided a nucleic acid analysis apparatus. The nucleic acid analysis apparatus includes a multi-color fluorescent excitation and detection device, a chamber, a fluid delivery unit, a thermal unit and a rotational driven unit. The multi-color fluorescent excitation and detection device comprises at least one illumination module, a cartridge and at least one detection module. Each of the at least one illumination module provides an illumination light at specified range of wavelengths. The cartridge comprises a detection chip comprising plural detection wells arranged around the peripheral of the detection chip. The detection chip is circular shape. Each of the detection wells is accommodated a corresponding fluorescent sample therein. Each of the detection wells includes a first wall and a second wall. The illumination light transmits through the first wall to illuminate on the fluorescent sample within the detection well so as to excite a fluorescent signal. The fluorescent signal emitted from the fluorescent sample transmits through the second wall. The at least one detection module receives the fluorescent signal emitted from the fluorescent sample through the corresponding second wall and converts the fluorescent signal to an electrical signal. The chamber receives the cartridge therein. The fluid delivery unit is connected with the chamber and adapted to transport samples within the cartridge for sample purification and/or nucleic acid extraction. The thermal unit is disposed in the chamber and adapted to provide a predefined temperature for nucleic acid amplification. The rotational driven unit is connected with the chamber and capable of rotating the cartridge with a predefined program.

The above contents of the present invention will become more readily apparent to those ordinarily skilled in the art after reviewing the following detailed description and accompanying drawings, in which:

### BRIEF DESCRIPTION OF THE DRAWINGS

FIG. 1 shows a schematic view of a nucleic acid analysis apparatus employing a multi-color fluorescent excitation and detection device according to the embodiment of the present invention;

FIG. 2 shows the nucleic acid analysis apparatus of FIG. 1 with opened chamber;

FIG. 3 shows the lock and release mechanism between the cartridge and the bottom chamber;

FIG. 4 shows the bottom view of the cartridge;

FIG. 5 shows a schematic view of the multi-color fluorescent excitation and detection device according to the embodiment of the present invention;

FIG. 6 is an enlarged schematic view showing the multi-color fluorescent excitation and detection device of FIG. 5.

FIG. 7 shows the excitation spectrum of the four types of targeted fluorescent probes and the pass bands of the four types of excitation filters;

FIG. 8 shows the emission spectrum of the four types of targeted fluorescent probes and the pass bands of the four types of emission filters;

FIG. 9 shows the structures of the rotational driven unit, the illumination module, the cartridge and the detection module;

FIG. 10 shows a schematic view of the multi-color fluorescent excitation and detection device according to another embodiment of the present invention; and

FIG. 11 is an enlarged schematic view showing the multi-color fluorescent excitation and detection device of FIG. 10.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a nucleic acid analysis apparatus with isothermal based amplification. More particularly, the present invention provides an all-in-one nucleic acid analysis apparatus with isothermal based amplification, which integrates a fluid delivery unit, a thermal unit, a rotational driven unit, and a multi-color fluorescent excitation and detection device on one single device, so that the processes of sample purification, nucleic acid extraction, nucleic acid amplification and nucleic acid detection can be performed on the all-in-one apparatus to realize nucleic acid analysis in real time.

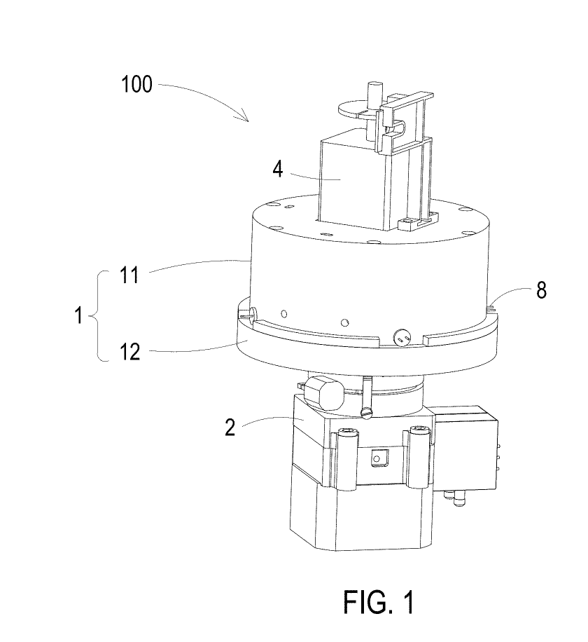

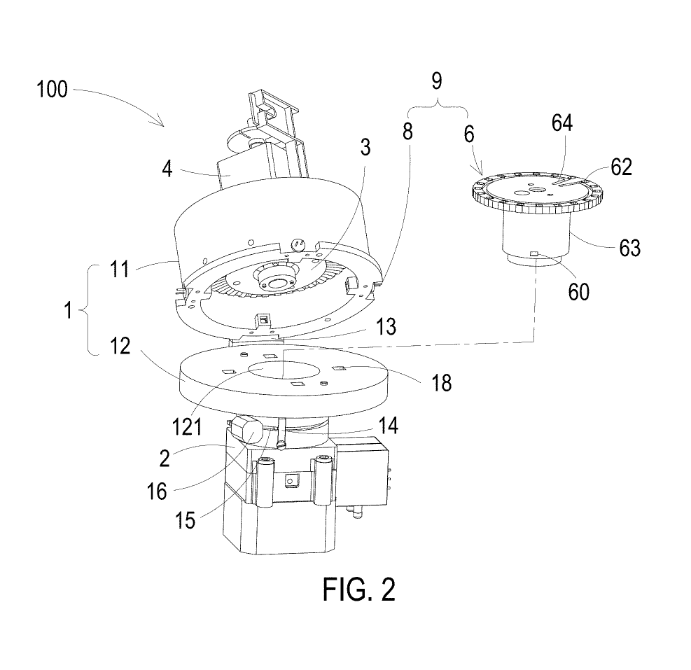

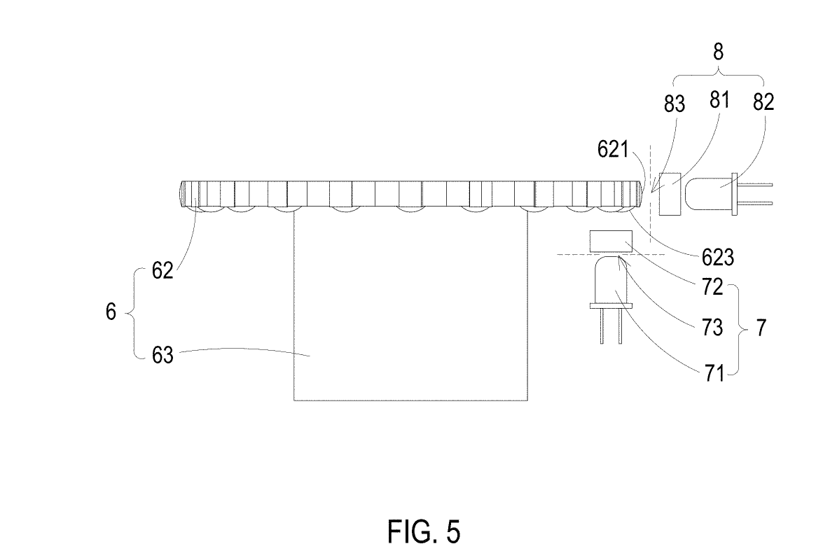

FIG. 1 shows a schematic view of the nucleic acid analysis apparatus according to the embodiment of the present invention, and FIG. 2 shows the nucleic acid analysis apparatus of FIG. 1, wherein the nucleic acid analysis apparatus is opened, and the cartridge is moved out of the nucleic acid analysis apparatus. As shown in FIGS. 1 and 2, the nucleic acid analysis apparatus 100 includes a chamber 1, a fluid delivery unit 2, a thermal unit 3, a rotational driven unit 4, and a multi-color fluorescent excitation and detection device 9, wherein the multi-color fluorescent excitation and detection device 9 includes a cartridge 6, at least one illumination module 7 (see FIG. 5) and at least one detection module 8. The chamber 1 is able to be opened for mounting the cartridge 6 therein.

The fluid delivery unit 2 is connected with the chamber 1 and adapted to transport reagents within the cartridge 6 for sample purification and/or nucleic acid extraction. The thermal unit 3 is disposed in the chamber 1 and adapted to provide a predefined temperature for nucleic acid amplification. The rotational driven unit 4 is connected with the chamber 1 and capable of rotating the cartridge 6 within the chamber 1 with a predefined program. In an embodiment, the rotational driven unit 4 is able to clamp the cartridge 6. The at least one illumination module and at least one detection module 8 are disposed on the chamber 1. Each of the at least one illumination module includes at least one optical component for excitation, and each of the at least one detection module 8 includes at least one optical component for detection, such as nucleic acid detection or sample reaction detection.

In an embodiment, the chamber 1 includes a top chamber 11 and a bottom chamber 12. The top chamber 11 and the bottom chamber 12 are connected through a hinge 13, but not limited thereto. The bottom chamber 12 has a cavity 121 specifically designed for mounting the cartridge 6 therein. The top chamber 11 can be opened, so that the cartridge 6 is able to be placed into the cavity 121 of the bottom chamber 12. When the top chamber 11 is closed, a confined space is formed in the chamber 1. In an embodiment, the shape of the chamber 1 could be but not limited as cylindrical, spherical, cubic, conical or olivary, and the chamber 1 could be made but not limited by metal, ceramic, polymer, polymer compound, wood, glass, or other materials as long as it is able to provide good thermal insulation.

The bottom chamber 12 is connected with the fluid delivery unit 2 through tubing or channels. Once the cartridge 6 is mounted in bottom chamber 12, the cartridge 6 is locked and forced to tightly contact the fluid delivery unit 2 without leakage. For example, the cartridge 6 is locked on the bottom chamber 12 by at least one fixing component, such as a clip but not limited thereto.

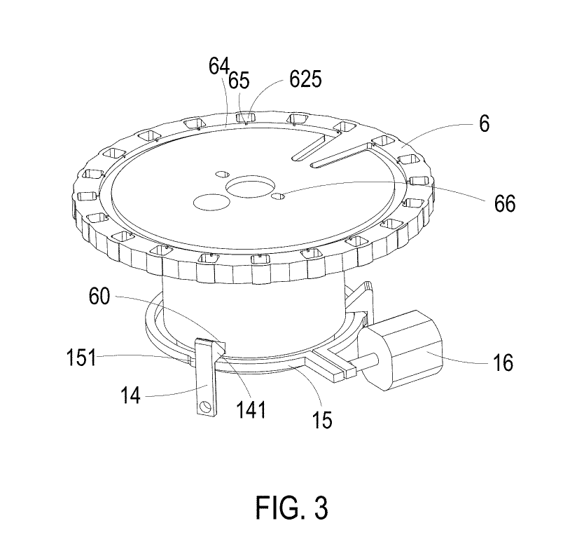

FIG. 3 shows the lock and release mechanism between the cartridge and the bottom chamber. As shown in the embodiment of FIGS. 2 and 3, the cartridge 6 includes at least one lock slot 60 on its cylindrical body, and the bottom chamber 12 includes at least one clip 14, a release ring 15, and a release actuator 16. The clip 14 is fixed at the bottom and has a hook 141 on the top. The clip 14 could be made by polymer or metal strip with elasticity. When the cartridge 6 is placed into the cavity 121 of the bottom chamber 12, the user pushes the cartridge 6 downwardly to make the hook 141 of clip 14 be engaged and locked with the lock slot 60 of the cartridge 6, and thus make the cartridge 6 tightly contact the fluid delivery unit 2. The release ring 15 surrounds the cylindrical body of the cartridge 6, and leans against the bottom surface of the hook 141. The release ring 15 is able to slide within a certain distance, and is connected with the release actuator 16, such as a solenoid actuator. When the cartridge 6 is to be released, the release actuator 16 is triggered to drag the release ring 15, then the convex structure 151 on the release ring 15 pushes the clip 14 to separate the hook 141 apart from the lock slot 60 and therefore release the cartridge 6. In an embodiment, the clip 14 could be operated by user manually or by the device automated on demand. Certainly, the lock and release mechanism is not limited to the clip 14 described above, and may be other fixing component as long as it is able to lock and release the cartridge 6.

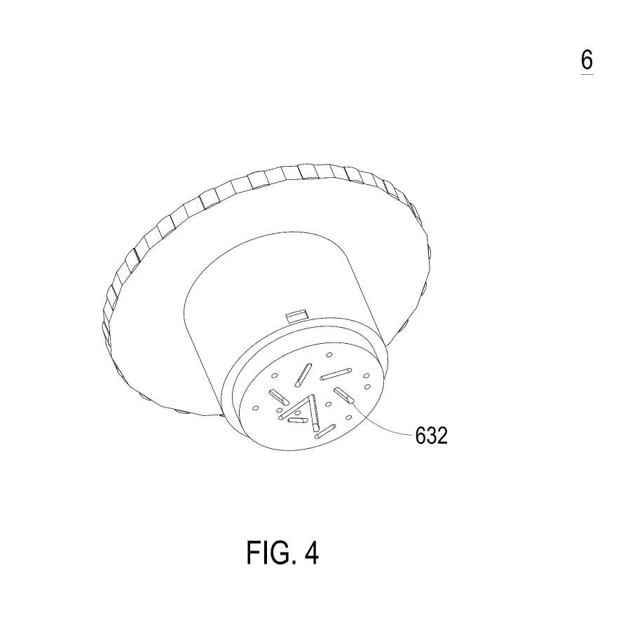

FIG. 4 shows the bottom view of the cartridge. As shown in FIGS. 2, 3 and 4, the cartridge 6 includes a detection chip 62 and a reagent storing body 63, and the detection chip 62 is disposed on the top of the reagent storing body 63. The detection chip 62 is a planar fluidic chip, and includes plural detection wells 625, at least one first channel 64 and at least one second channel 65. The at least one first channel 64 is connected with the detection wells 625 through the at least one second channel 65. In an embodiment, the detection wells 625 are arranged around the peripheral of the detection chip 62 and contains samples or reagents for nucleic acid amplification and/or detection. For example, the detection wells 625 may be coated with samples or reagents for nucleic acid amplification and/or detection, such as reagents containing different fluorescent dyes. The number of the detection wells 625 is not limited, and may be 40 or even more, and the apparatus could perform multiplexing nucleic acid analysis. In an embodiment, the shape of the detection chip 62 is substantially a circular shape, so that the detection chip 62 has plural curve side surfaces to be in line with the at least one detection module 8 to facilitate light focusing.

The reagent storing body 63 includes plural reagent cells (not shown) used to store reagents for sample purification and/or nucleic acid extraction. The reagent storing body 63 also includes plural channels connected with the reagent cells for fluid delivery. In an embodiment, the reagent storing body 63 is but not limited to a cylindrical body. The reagent storing body 63 further includes plural openings 632 at the bottom surface of the reagent storing body 63, and the openings 632 are communicated with the reagent cells through the channels. The shape of the openings 632 may be but not limited to circular, linear or other regular or irregular shape. The detection chip 62 further includes at least one opening 66 at the top surface of the detection chip 62, and the opening 66 aligns and communicates with at least one reagent cell of the reagent storing body 63 for adding sample to the cartridge 6.

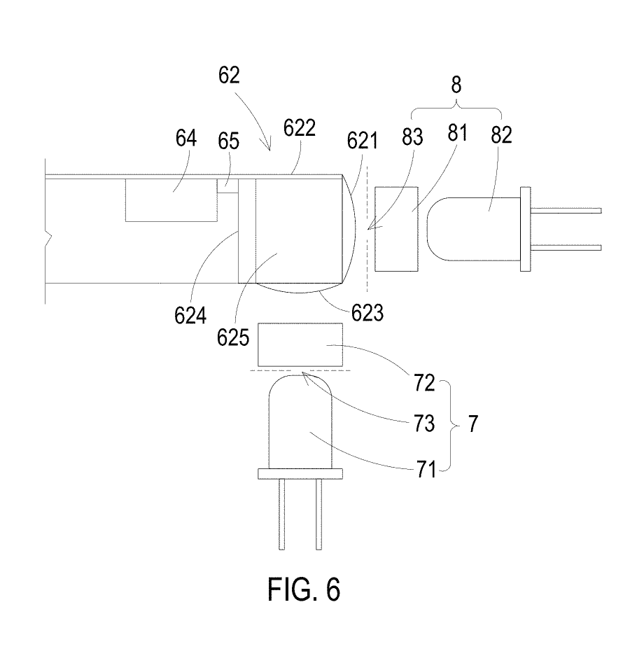

FIG. 5 shows a schematic view of the multi-color fluorescent excitation and detection device according to the embodiment of the present invention. FIG. 6 is an enlarged schematic view showing the multi-color fluorescent excitation and detection device of FIG. 5. As shown in FIGS. 1, 2, 5 and 6, the multi-color fluorescent excitation and detection device 9 comprises a cartridge 6, at least one illumination module 7 and at least one detection module 8. Preferably but not exclusively, the multi-color fluorescent excitation and detection device 9 includes four illumination modules 7 and four detection modules 8. Each of the illumination modules 7 is disposed in a corresponding accommodation space 18 of the bottom chamber 12 (see FIG. 2) and provides an illumination light at specified range of wavelengths.

Each of the detection wells 625 includes a first wall 623, a second wall 621, a third wall 622, a fourth wall 624, a fifth wall and a sixth wall (not shown). The first wall 623 is opposite to the third wall 622. The second wall 621 is opposite to the fourth wall 624. The fifth wall is opposite to the sixth wall. The second wall 621, the fourth wall 624, the fifth wall and the sixth wall are connected with and located between the first wall 623 and the third wall 622. In this embodiment, the first wall 623 is a lower wall, the second wall 621 is a front wall, the third wall 622 is an upper wall, the fourth wall 624 is a rear wall, the fifth wall is a first lateral wall, and the sixth wall is a second lateral wall.

The illumination light emitted from the illumination module 7 transmits through the first wall 623 (i.e. lower wall) of the detection well 625 to illuminate on the fluorescent sample within the detection well 625 so as to excite a fluorescent signal. The fluorescent signal emitted from the fluorescent sample transmits through the second wall 621 (i.e. front wall) of the detection well 625. The detection module 8 receives the fluorescent signal transmitted from the second wall 621 of the detection well 625 and converts the fluorescent signal to an electrical signal.

In an embodiment, the first walls 623 of the detection wells 625 have curve surfaces aligned with the at least one illumination module 7, and the second walls 621 of the detection wells 625 have curve surfaces aligned with the at least one detection module 8 during nucleic acid detection. The first wall 623 of the detection well 625 has a specified curvature, such as circular. The shape of the first wall 623 is not limited to the circular and it may also be ellipse or other shape. Therefore, when the illumination light transmits through the first wall 623 of the detection well 625, the illumination light could be focused on the fluorescent sample within the detection well 625 through the first wall 623. The second wall 621 of the detection well 625 has a specified curvature, such as circular. The shape of the second wall 621 of the detection well 625 is not limited to the circular and it may also be ellipse or other shape. Therefore, when the fluorescent signal emitted from the fluorescent sample transmits through the second wall 621 of the detection well 625, the fluorescent signal could be focused on the detection module 8 through the second wall 621.

Please refer to FIGS. 5 and 6 again, the illumination module 7 is located beside the first wall 623 of the detection well 625, and the optical axis of the illumination module 7 is aligned with the first wall 623 of the detection well 625, so that the first wall 623 of the detection well 625 receives the illumination light at specified range of wavelengths. The detection module 8 is located beside the second wall 621 of the detection well 625, and the optical axis of the detection module 8 is aligned with the second wall 621 of the detection well 625, so that the detection module 8 receives the fluorescent signal transmitted through the second wall 621 of the detection well 625.

In an embodiment, the illumination module 7 comprises a light source 71 and a first filter 72. The light source 71, such as a LED or a laser diode, is configured to emit the illumination light at wide bandwidth of wavelengths. The first filter 72 is arranged between the light source 71 and the first wall 723. The first filter 72 allows the illumination light at the specified range of wavelengths emitted from the light source 71 to pass through and forbids the unwanted range of wavelengths emitted from the light source 71 to pass through.

The illumination module 7 further comprises a first pinhole 73. The first pinhole 73 is arranged between the light source 71 and the first filter 72. The first pinhole 73 of the illumination module 7 guides the illumination light generated from the light source 71 to be aligned on the first filter 72 and the first wall 623 of the detection well 625. An aperture of the first pinhole 73 is ranged from 2.0 mm to 3.0 mm, but not limited thereto.

In an embodiment, the first channel 64 is in communication with the detection wells 625 through the corresponding second channels 65. The first channel 64 is used to dispense the sample to the detection wells 625. Preferably, a cross-section area of the second channel 65 is smaller than a cross-section area of the first channel 64. Therefore, the second channel 65 has a capillary value for passive flow controlling.

In an embodiment, the third wall 622 and the first wall 623 of the detection well 625 are optical membranes respectively. A thickness of the optical membrane of the third wall 622 and a thickness of the optical membrane of the first wall 623 are ranged from 0.1 mm to 0.2 mm, respectively, but not limited thereto. A refractive index of the optical membrane of the third wall 622 and a refractive index of the optical membrane of the first wall 623 are ranged from 1.3 to 1.6, respectively, but not limited thereto.

In an embodiment, the volume of the detection well 625 of the detection chip 62 is ranged from 10 uL to 50 uL, but not limited thereto. The detection chip 62 is made of polycarbonate (PC), polymethyl methacrylate (PMMA) or cyclic olefin copolymer (COC). A refractive index of the detection well 625 of the detection chip 62 is ranged from 1.3 to 1.6, but not limited thereto.

The detection module 8 comprises a second filter 81 and a detector 82. The second filter 81 is configured to receive the fluorescent signal transmitted from the second wall 621 of the detection well 625 and allow the fluorescent signal at a specific range of wavelengths to pass through and forbid the unwanted range of wavelengths to pass through. The detector 82 is configured to receive the fluorescent signal at the specified range of wavelengths passed through the second filter 81 and convert the fluorescent signal to the electrical signal. In an embodiment, the detector 82 is but not limited to a photodiode (PD), avalanche photodiode (APD), charge coupled device (CCD) or complementary metal-oxide semiconductor (CMOS).

The detection module 8 further comprises a second pinhole 83. The second pinhole 83 is arranged between the second wall 621 of the detection well 625 and the second filter 81. The second pinhole 83 of the detection module 8 guides the fluorescent signal generated from the fluorescent sample to be aligned on the detection module 8. An aperture of the second pinhole 83 is ranged from 2.0 mm to 3.0 mm, but not limited thereto.

In some embodiments, the multi-color fluorescent excitation and detection device 9 comprises plural illumination modules 7 and plural detection modules 8, for example but not limited to four illumination modules 7 and four detection modules 8. The plural illumination modules 7 provide different color illumination lights for fluorescent detection to the respective detection wells 625. The plural detection modules 8 receive the corresponding fluorescent signals, and thus the plural detection modules 8 can detect multiple targets simultaneously and realize multiplexing detection.

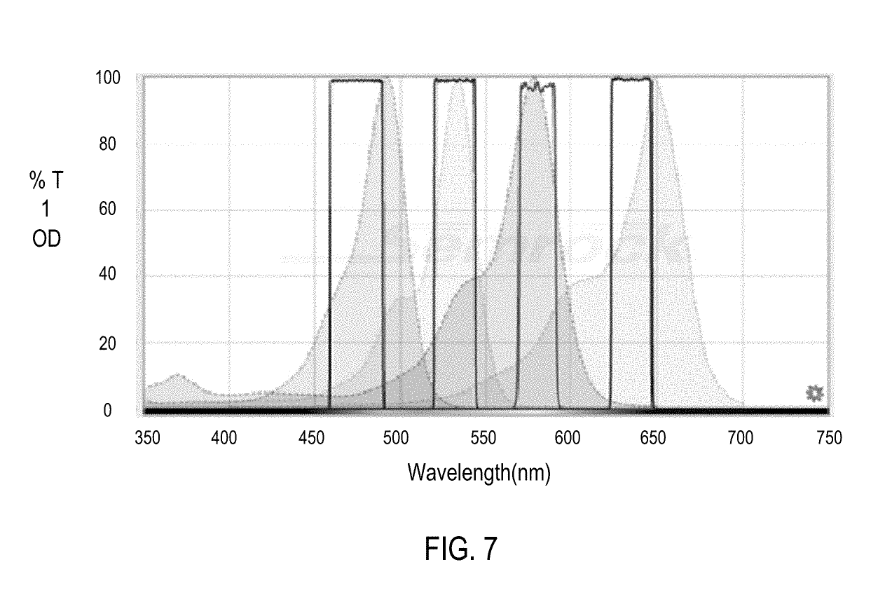

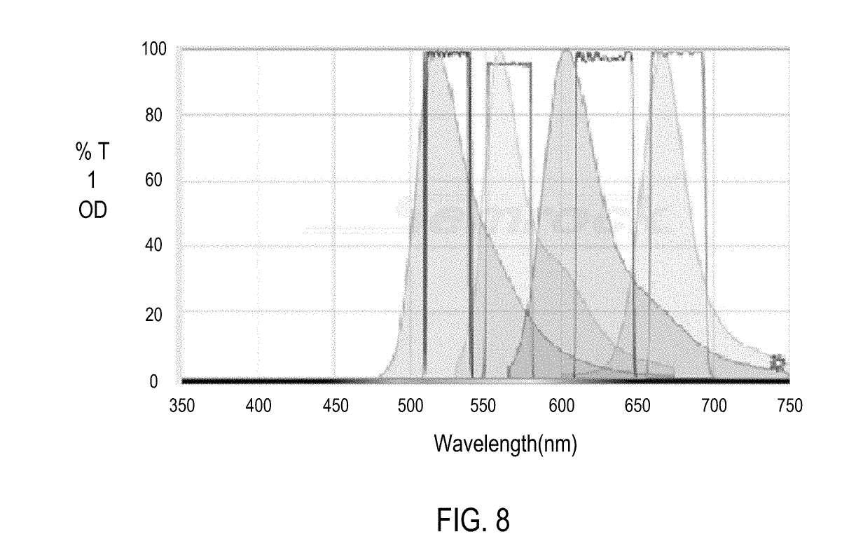

In an embodiment, four types of the fluorescent dyes are of interest. Each of the detection well 625 is filled with a mixture of four different fluorescent probes. These dyes are standard fluorescent dyes, and their acronyms are FAM, HEX, ROX, and Cy5. The excitation and emission spectra of the fluorescent dyes are shown in FIGS. 7 and 8, respectively. Although the embodiment of the present invention is described with these dyes, the system of the present invention is not limited to these four types of dyes.

Table 1 shows signal to noise ratio (SNR) of four types of the fluorescent dyes applied to the multi-color fluorescent excitation and detection device 9, wherein the concentration of four types of the fluorescent dyes are 320 nM respectively. It clearly presents that signal to noise ratio of four types of the fluorescent dyes applied to the multi-color fluorescent excitation and detection device 9 are high. That means sensitivity of the multi-color fluorescent excitation and detection device 9 is great.

TABLE 1

| | FAM | HEX | ROX | Cy5 |
|---|---|---|---|---|
| Background | 4.83 | 11.38 | 0.3 | 4.4 |
| (mV) | | | | |
| Light source | 349.1 | 440.2 | 16.33 | 400.7 |
| (mV) | | | | |
| SNR_320 nM | 72.34 | 38.69 | 53.74 | 91.1 |

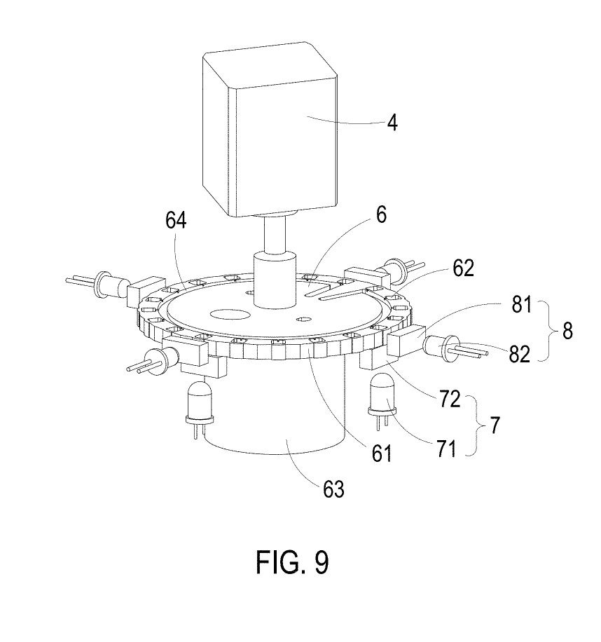

FIG. 9 shows the structures of the rotational driven unit 4, the illumination module 7, the cartridge 6 and the detection module 8. As shown in FIG. 9, the rotational driven unit 4 further includes a cartridge clamp used to clamp and rotate the cartridge 6. Once the cartridge 6 is clamped, it is able to rotate within the chamber 1, actuated by the rotational driven unit 4. Various mechanisms are capable of realizing cartridge clamp and release on demand. For example, the cartridge clamp may also be solenoid, screw, nut, press fitted parts, frictional parts, grip, pincer, epoxy, chemical bonding or other types as long as it is able to clamp the cartridge 6 on demand.

In an embodiment, the rotational driven unit 4 is mounted on the top chamber 11. The rotational driven unit 4 is but not limited to a motor, and it may also be solenoid, manual operation, spring, clockwork or other components, and is able to clamp and rotate the cartridge 6 at predefined angles and pass each detection well 625 in alignment with each illumination module 7 and each detection module 8 sequentially.

In an embodiment, the illumination module 7 is mounted in the accommodation space 18 of the bottom chamber 12. During the operation, each illumination module 7 aligns to one of the detection wells 625 of the cartridge 6 in order to offer effective illumination for detection. The detection module 8 is mounted in the edge of the top chamber 11 to realize the optical detection so that the sample could be detected in real time during the nucleic acid amplification. Once the cartridge 6 is clamped, the detection module 8 is in line with one of the detection wells 625 on the cartridge 6 and therefore the results of nucleic acid analysis are interpreted. The rotation of the cartridge 6 allows each detection well 625 pass through different illumination module 7 and detection module 8 sequentially. In an embodiment, each illumination module 7 and detection module 8 could offer unique color of illumination and detection so as to provide different colors for fluorescent based detection, and thus the nucleic acid analysis apparatus 100 can detect multiple targets simultaneously and realize multiplexing detection.

In realistic operation, there probably has some deviation when the optical axis of the illumination module 7 or the optical axis of the detection module 8 is aligned with the detection well 625. Table 2 shows signal to noise ratio of two types of the fluorescent dyes applied to the multi-color fluorescent excitation and detection device 9 when the optical axis of the illumination module 7 or the optical axis of the detection module 8 is aligned with the detection well 625 with deviation. It clearly presents that full-width at half maximum (FWHM) of signal to noise ratio of two types of the fluorescent dyes applied to the multi-color fluorescent excitation and detection device 9 is within −2 degree to 2 degree. That means the multi-color fluorescent excitation and detection device 9 allows some deviation when the optical axis of the illumination module 7 or the optical axis of the detection module 8 is aligned with the detection well 625.

TABLE 2

| Angle (degree) | ROX_SNR | ROX_SNR (%) | FAM_SNR | FAM_SNR (%) |
|---|---|---|---|---|
| 0 | 26.94 | 100 | 76.97 | 100 |
| ±1 | 19.63 | 73 | 57.77 | 75 |
| ±2 | 13.36 | 50 | 41.16 | 53 |
| ±3 | 8.15 | 30 | 27.13 | 35 |
| ±4 | 3.97 | 15 | 15.69 | 20 |
| ±5 | 0.84 | 3 | 6.84 | 9 |

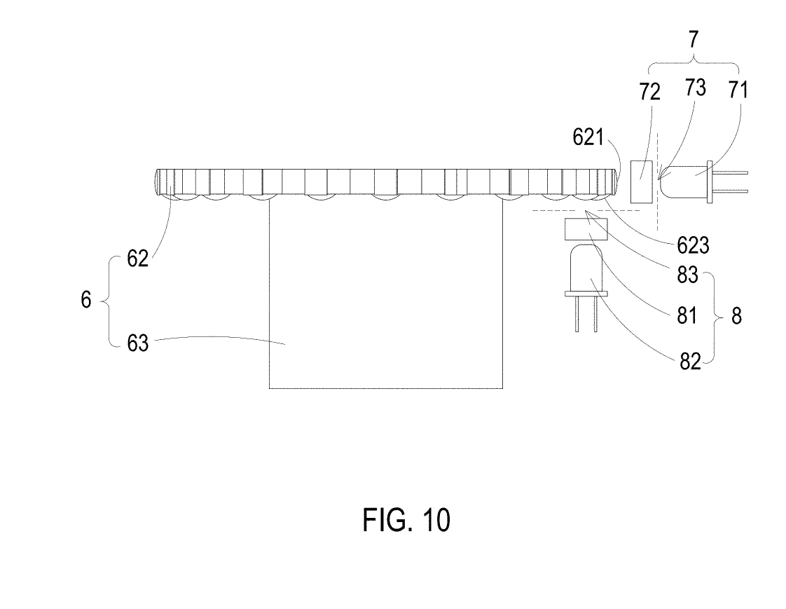

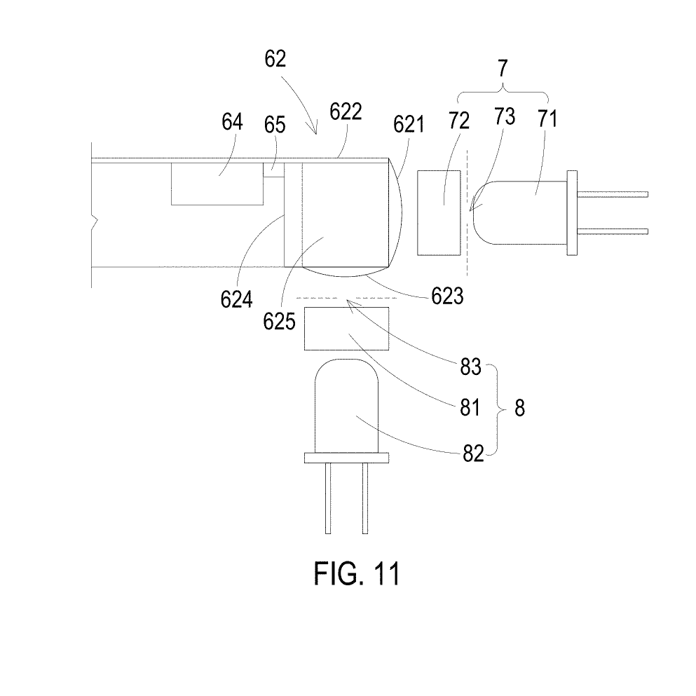

FIG. 10 shows a schematic view of the multi-color fluorescent excitation and detection device according to another embodiment of the present invention. FIG. 11 is an enlarged schematic view showing the multi-color fluorescent excitation and detection device of FIG. 10. In this embodiment, the structures and functions of the cartridge 6, the illumination module 7 and the detection module 8 of the multi-color fluorescent excitation and detection device 9 are similar to those of the multi-color fluorescent excitation and detection device 9 of FIGS. 5 and 6. Component parts and elements corresponding to those of the first embodiment are designated by identical numeral references, and detailed descriptions thereof are omitted. In this embodiment, the illumination module 7 is located beside the front wall and the optical axis of the illumination module 7 is aligned with the front wall, and the detection module 8 is located beside the lower wall and the optical axis of the detection module 8 is aligned with the lower wall. Namely, the illumination light emitted from the illumination module 7 transmits through the front wall of the detection well 625 to illuminate on the fluorescent sample within the detection well 625 so as to excite a fluorescent signal. The fluorescent signal emitted from the fluorescent sample transmits through the lower wall of the detection well 625. The detection module 8 receives the fluorescent signal transmitted from the lower wall of the detection well 625 and converts the fluorescent signal to an electrical signal. It is noted that the positions of the illumination module 7 and the detection module 8 are not limited to the above-mentioned embodiments and can be varied according to the practical requirements.

In conclusion, the embodiment of the present invention provides a multi-color fluorescent excitation and detection device and a nucleic acid analysis apparatus. The multi-color fluorescent excitation and detection device which integrates the illumination module, the cartridge and the detection module on one single device, so that the multi-color fluorescent excitation and detection device has compact structure, smaller volume and lighter weight. Besides, the multi-color fluorescent excitation and detection device does not need expensive optical components so that the multi-color fluorescent excitation and detection device has lower cost. Further, due to the arrangements of multiple illumination modules, multiple detection wells and multiple detection modules, both multiplexing nucleic acid analysis and multiple color multiplexing detections are achieved. Moreover, signal to noise of the multi-color fluorescent excitation and detection device of the present invention is high. In addition, the deviation of the rotating of the cartridge is allowed.

While the invention has been described in terms of what is presently considered to be the most practical and preferred embodiments, it is to be understood that the invention needs not be limited to the disclosed embodiment.

What is claimed is:

1. A multi-color fluorescent excitation and detection device, comprising:
at least one illumination module configured to provide an illumination light at specified range of wavelengths;
a cartridge comprising a detection chip comprising plural detection wells arranged around the peripheral of the detection chip, wherein each of the detection wells is accommodated a corresponding fluorescent sample therein and includes a first wall and a second wall, wherein the illumination light transmits through the first wall to illuminate on the fluorescent sample within the detection well so as to excite a fluorescent signal, and the fluorescent signal emitted from the fluorescent sample transmits through the second wall; and
at least one detection module configured to receive the fluorescent signal and convert the fluorescent signal to an electrical signal.

2. The multi-color fluorescent excitation and detection device according to claim 1, wherein the illumination module is located beside the first wall and the optical axis of the illumination module is aligned with the first wall, and the detection module is located beside the second wall and the optical axis of the detection module is aligned with the second wall.

3. The multi-color fluorescent excitation and detection device according to claim 1, wherein the first wall is a lower wall and the second wall is a front wall.

4. The multi-color fluorescent excitation and detection device according to claim 3, wherein each of the detection wells further comprises a third wall, a fourth wall, a fifth wall and a sixth wall, the third wall is opposite to the first wall, the second wall is opposite to the fourth wall, the fifth wall is opposite to the sixth wall, wherein the third wall is an upper wall, the fourth wall is a rear wall, the fifth wall is a first lateral wall, and the sixth wall is a second later wall.

5. The multi-color fluorescent excitation and detection device according to claim 4, wherein the third wall and the first wall are optical membranes respectively, wherein a thickness of the optical membrane of the third wall and a thickness of the optical membrane of the first wall are ranged from 0.1 mm to 0.2 mm, respectively, wherein a refractive index of the optical membrane of the third wall and a refractive index of the optical membrane of the first wall are ranged from 1.3 to 1.6, respectively.

6. The multi-color fluorescent excitation and detection device according to claim 1, wherein the first wall is a front wall and the second wall is a lower wall.

7. The multi-color fluorescent excitation and detection device according to claim 1, wherein the illumination module comprises:
a light source configured to emit the illumination light at wide bandwidth of wavelengths; and
a first filter arranged between the light source and the first wall and allowing the illumination light at the specified range of wavelengths to pass through.

8. The multi-color fluorescent excitation and detection device according to claim 7, wherein the light source is a LED or a laser diode.

9. The multi-color fluorescent excitation and detection device according to claim 7, wherein the illumination module further comprises a first pinhole arranged between the light source and the first filter, wherein an aperture of the first pinhole is ranged from 2.0 mm to 3.0 mm.

10. The multi-color fluorescent excitation and detection device according to claim 1, wherein the volume of the detection well is ranged from 10 uL to 50 uL.

11. The multi-color fluorescent excitation and detection device according to claim 1, wherein the detection chip are made of polycarbonate, polymethyl methacrylate or cyclic olefin copolymer, wherein a refractive index of the detection well is ranged from 1.3 to 1.6.

12. The multi-color fluorescent excitation and detection device according to claim 1, wherein the detection module comprises:
a second filter configured to receive the fluorescent signal and allow the fluorescent signal at a specific range of wavelengths to pass through; and
a detector configured to receive the fluorescent signal at the specified range of wavelengths and convert the fluorescent signal to the electrical signal.

13. The multi-color fluorescent excitation and detection device according to claim 12, wherein the detection module further comprises a second pinhole arranged between the second wall and the second filter, wherein an aperture of the second pinhole is ranged from 2.0 mm to 3.0 mm.

14. The multi-color fluorescent excitation and detection device according to claim 12, wherein the detector is a photodiode, an avalanche photodiode, a charge coupled device or a complementary metal-oxide semiconductor.

15. The multi-color fluorescent excitation and detection device according to claim 1, wherein the multi-color fluorescent excitation and detection device comprises plural illumination modules and plural detection modules, wherein the plural illumination modules provide different color illumination lights to the respective detection wells, and the plural detection modules receive the corresponding fluorescent signals.

16. The multi-color fluorescent excitation and detection device according to claim 1, wherein the detection chip is a planar fluidic chip and includes plural detection wells, at least one first channel and at least one second channel, wherein the at least one first channel is connected with the plural detection wells through the at least one second channel.

17. The multi-color fluorescent excitation and detection device according to claim 1, wherein the detection chip is circular shape, and each of the first wall and the second wall has a specified curvature.

18. A nucleic acid analysis apparatus, comprising:
a multi-color fluorescent excitation and detection device comprising:
at least one illumination module configured to provide an illumination light at specified range of wavelengths;
a cartridge comprising a detection chip comprising plural detection wells arranged around the peripheral of the detection chip, wherein each of the detection wells is accommodated a corresponding fluorescent sample therein and includes a first wall and a second wall, wherein the illumination light transmits through the first wall to illuminate on the fluorescent sample within the detection well so as to excite a fluorescent signal, and the fluorescent signal emitted from the fluorescent sample transmits through the second wall; and
at least one detection module configured to receive the fluorescent signal and convert the fluorescent signal to an electrical signal;
a chamber receiving the cartridge therein;
a fluid delivery unit connected with the chamber and adapted to transport samples within the cartridge for sample purification and/or nucleic acid extraction;
a thermal unit disposed in the chamber and adapted to provide a predefined temperature for nucleic acid amplification; and
a rotational driven unit connected with the chamber and capable of rotating the cartridge with a predefined program.

19. The nucleic acid analysis apparatus according to claim 18, wherein the chamber is able to be opened and comprises a top chamber and a bottom chamber, wherein each of the at least one illumination module is disposed in an accommodation space of the bottom chamber, and each of the detection module is disposed on the top chamber.

20. The nucleic acid analysis apparatus according to claim 18, wherein the illumination module comprises:
a light source configured to emit the illumination light at wide bandwidth of wavelengths; and
a first filter arranged between the light source and the first wall and allowing the illumination light at the specified range of wavelengths to pass through.

21. The nucleic acid analysis apparatus according to claim 20, wherein the illumination module further comprises a first pinhole arranged between the light source and the first filter, wherein an aperture of the first pinhole is ranged from 2.0 mm to 3.0 mm.

22. The nucleic acid analysis apparatus according to claim 18, wherein the detection module comprises:
a second filter configured to receive the fluorescent signal and allow the fluorescent signal at a specific range of wavelengths to pass through; and
a detector configured to receive the fluorescent signal at the specified range of wavelengths and convert the fluorescent signal to the electrical signal.

23. The nucleic acid analysis apparatus according to claim 22, wherein the detection module further comprises a second pinhole arranged between the second wall and the second filter, wherein an aperture of the second pinhole is ranged from 2.0 mm to 3.0 mm.

24. The nucleic acid analysis apparatus according to claim 18, wherein the first wall is a lower wall and the second wall is a front wall, or the first wall is a front wall and the second wall is a lower wall.

25. The nucleic acid analysis apparatus according to claim 18, wherein the detection chip is circular shape, and each of the first wall and the second wall has a specified curvature.
